(19) United States
(12) Patent Application Publication
(10) Pub. No.: US 2005/0171706 A1
(43) Pub. Date: Aug. 4, 2005

(54) Method for determining field radiation levels for a radiating device

(76) Inventor: Mark Leckenby, Queensland (AU)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/516,903

(22) PCT Filed: Jun. 5, 2003
(86) PCT No.: PCT/AU03/00700

(30) Foreign Application Priority Data
Jun. 6, 2002 (AU) PS 2784

(51) Int. Cl. G06F 19/00

(52) U.S. Cl. 702/40

(57) ABSTRACT

A method for determining field radiation levels for a radiating device comprising determining far field radiation characteristics of a radiating device, providing a model of the radiating device, which model approximates the determined far field radiation characteristics and determining a near field radiation characteristic from the model for at least one point in space.

### FIELD OF THE INVENTION

The present invention relates to radiating devices such as antennas.

### BACKGROUND OF THE INVENTION

For health and safety reasons radiation levels from antennas must be accurately monitored and controlled. Regulatory bodies require radio frequency wireless operators to ensure radiation levels comply with the relevant health and safety standards in place. This requires the collection of technical data relating to radiation levels and exposure limits around a relevant antenna.

Existing techniques for radiation estimation approximate the characteristics of the antenna to a point source and use far field theory to calculate radiation levels for an antenna.

The present invention is aimed at providing an improved method for determining radiation levels for radiating devices such as antennas.

### SUMMARY OF THE INVENTION

According to one aspect of the present invention there is provided a method for determining field radiation levels for a radiating device comprising the steps of determining far field radiation characteristics of a radiating device, providing a model of the radiating device, which model approximates the determined far field radiation characteristics and determining a near field radiation characteristic from the model for at least one point in space.

It is preferred that the model is chosen to approximate near field radiation characteristics.

It is preferred that the method includes the step of determining a boundary between near field and far field radiation.

The method may include the step of determining near field radiation density from the model.

Preferably the method includes the step of determining near field radiation power density level over a plurality of positions in space. It is to be understood that space includes occupied (physical structure present) or unoccupied space and any particular area around the radiating device.

It is preferred that the method includes the step of radiation pattern or gain characteristics of the radiating device from the two orthogonal far field radiation patterns.

It is preferred that radiation pattern or gain characteristics are determined from documented data such as that available in handbooks.

Preferably the method includes the step of determining 3 dB beam width in the two orthogonal far field radiation patterns.

It is preferred that the method includes determining physical characteristics of the device to determine the far field radiation characteristics.

Preferably the method includes the step of providing a model including representing the device by a plurality of radiation sources.

According to one embodiment of the invention the radiating device comprises a wire antenna.

The method may include the step of providing a model including estimating the length and spacing of each wire element forming the wire antenna.

Each radiation source may comprise one wire element.

Preferably the method includes calculating mutual coupling between all wire elements of the radiating device.

Preferably the method includes assembling an N by N impedance matrix for the radiation sources.

The method preferably includes calculating voltage for each wire element.

The method may also include determining current in each wire element.

Preferably the method includes multiplying an inverse impedance matrix by a column voltage vector (zero for parasitic elements and 1 volt for driven elements).

The method preferably includes assigning one or more Huygen's wavelet point sources to each wire element.

The method may also include calculating magnitude and phase of each point source from current determined.

The method preferably includes assuming a sin(θ) dependence for each wire element ((θ) being measured from the direction of the elements) and summing the contribution of each point source to each point in space within the near field radiation pattern.

It is preferred that the method includes both near field and far field effects when calculating the contribution of each point source.

The method preferably includes scaling field strengths determined at each point in space, by power supplied to the radiating device.

The method preferably includes radiating devices which are Yagi-Uda, log periodic, single or phased arrays of monopoles, dipoles, rhombic antennas and other regular or irregular wire antennas.

It is preferred that the method includes providing a single point source for each wire element with a length less than half the wavelength of radiation emitted from the radiating device.

The number of point sources for a radiating device will preferably be a multiple of the wavelength divided by two, i.e. twice the length of the radiating device divided by the wavelength.

Preferably the method includes providing scaling factors for miscellaneous effects such as weather, obstacles, other antennas, metallic structures and dielectric structures or other factors which affect radiation characteristics.

According to another embodiment of the present invention the radiating device is an aperture antenna.

Preferably the method includes determining physical characteristics of the aperture antenna from the beam width characteristics.

The physical characteristics include physical size, impedance, the size of the aperture and field distribution.

The step of providing a model may include representing the aperture by at least one Huygen's wavelet source.

Preferably the method includes the step of summing the contribution from each wavelet source at each point in space.

It is preferred that the method includes the step of summing the contribution from each wavelet source over a three dimensional coordinate system in space, e.g. rectangular, circular or polar coordinate system.

Preferably the contribution from each wavelet source determined includes power, voltage and current.

It is preferred that power density level at each point in space is determined using known power density formulas such as those described in more detail hereinafter.

According to another aspect of the present invention there is provided a method of estimating radiation power density of electromagnetic radiation comprising the steps of identifying a radiating device, representing the radiation device as a plurality of point sources which radiate electromagnetic radiation, estimating power density level at a plurality of positions in space for each point source and determining the total power density level at each position, by summing the contribution of each point source to the respective positions in space.

It is preferred that the method includes displaying the power density level for a plurality of positions.

Preferably the method includes displaying the power density levels in graphical, tabulated, diagrammatical, pictorial or other form.

The method may include choosing positions which fit into a two-dimensional or three dimensional coordinate system.

Preferably point sources include any portion which requires at least two portions to represent the radiating device.

Preferably the method includes summing the power density level determined at one position for all point sources representing the radiating device prior to estimating the power density level at another position.

Alternatively the method includes estimating the power density level for the plurality of positions for one point source, storing the estimated power density levels then estimating and storing the power density levels for the plurality of positions for another point source and summing stored power density levels for each point source at each position to calculate a resultant power density level at each position.

It is preferred that the method includes identifying a plurality of radiating devices.

The method may include representing each radiating device as a plurality of point sources.

Preferably the method includes calculating the total power density level for each radiating device.

The method may include calculating the total power density level for each point source at each position and summing power density levels calculated at each position.

Preferably the distance between each point source is determined by the distance between points in space. Thus in a rectangular coordinate system the spacing between grid points will determine the spacing between point sources, with closer distances between adjacent points in space resulting in more point sources for the radiating device.

It is preferred that the electromagnetic radiation measured is radio frequency electromagnetic radiation. However other radiation is included.

Preferably the method includes calculating far field and near field tapering characteristics for the radiating device. This may be accomplished using predetermined formula or field measurements.

Preferably the error measured is radio frequency error.

Preferably the method includes calculating the far field and near field tapering characteristics for each position.

Preferably far field Pd formula is

$$Pd = \frac{PoweratAntenna * {10}^{\frac{Gd + 2.15}{10}}}{4 π {Di}^{2}}$$

Gd=Antenna gain with respect to dipole of analysis angle
PaA=Power sent to antenna after lossy items.
Di=Distance from antenna.

$$\begin{matrix}Preferably D far field distance = \frac{λ}{2 π \\} \\ = \frac{2 ( theantennaseffectiveaperture )}{if aperture > 1 λ}\end{matrix}$$
Near field calculations—define break point of 0.16 times if aperture >1λ.
Pd_{paraNF}=41.3*Pd (para−parabolic aperture)
Breakpoint=0.16 Dff−parabolic aperture
   =0.25 Dff−rectangular aperture
Pd_{RectNF}=Pd

According to another embodiment of the present invention there is provided a method of determining field radiation levels for a radiating device comprising the steps of determining far field radiation characteristics of a radiating device, determining the boundary between near field and far field radiation, determining the displacement of a point in space relative to the closest point on the radiating device and calculating the power density level at the point in space.

Preferably, the method of determining field radiation levels for a radiating device utilising the closest point method includes the step of determining characteristics of the radiating device in a similar manner to that used in connection with any one of the previous aspects or embodiments of the invention.

It is preferred that the power density level is determined by the aforementioned formula for Pd.

It is preferred that the power density formulas are modified according to modification factors affecting the gain of the radiating device and the degradation of radiation as a function of the displacement of the point in space from the radiating device.

The method may include modeling the radiating device as a plurality of point sources.

Preferably displacement is determined by determining X, Y, Z vectors in space.

Preferably the displacement is determined using azimuth and elevation angles of the point in space.

It is preferred that the method includes determining the orientation of the radiating device in space to determine down tilt.

The method may include the step of determining any offset in the displacement as a result of down tilt of the radiating device.

The method preferably includes the step of determining if the point in space is outside the width plane or length plane or height of the radiating device.

Preferably the method includes the step of calculating the effective reduction of antenna aperture as a result of the displacement of the point in space from the radiating device.

### BRIEF DESCRIPTION OF THE DRAWINGS

A preferred embodiment of the present invention will now be described by way of example only with reference to the accompanying drawings:

FIG. 1 shows a schematic diagram of a method of determining power density of a point in space determined using a closest point algorithm;

FIG. 2 shows a schematic diagram of a method of performing power density of a point in space determined using a Hyugen's wavelet method for an aperture antenna;

FIG. 3 shows exposure limit boundaries of a test antenna using traditional modeling techniques;

FIG. 4 shows exposure limit boundaries for the same test antenna using a closest point algorithm technique;

FIG. 5 shows a power density plot for the test antenna exposure limit boundaries shown in FIG. 3; and

FIG. 6 shows a power density plot for the test antenna modeled according to the closest point algorithm in accordance with the present invention.

The best mode of performing the present invention will be described with reference to three different embodiments.

Antennas typically fall into two main categories. One of these is wire antennas and the other is aperture antennas.

A method for determining power density radiation levels for aperture antennas in accordance with the preferred embodiment of the invention may incorporate a closest point algorithm technique or a multiple point source technique.

Power Density Calculations

As described in the Microwave Engineers Handbook, Volume 2, Artech House 1971 to Sadd, Theodore [1], the simplest way of estimating the power density radiated from antennas is to apply the far field power density formula to a point source representation of an antenna.

To achieve sufficient accuracy manufacturers far field gain patterns must be used. These exhibit the antenna far field gain characteristics for all directions (i.e. 0 to 360°) in the horizontal and vertical planes. The far field power density formula is given by

$$Pd = \frac{PoweratAntenna * {10}^{\frac{Gd + 2.15}{10}}}{4 π {Di}^{2}}$$

Where Pd is the estimated power density, Gd is the antennas gain with respect to a dipole at the analysis angle, PoweratAntenna is the power sent to the antenna after lossy items such as a signal feeders, Di is the distance from the antenna. Units for the formula are Watts per centimeter squared.

The inventor has observed that this far field estimation grossly overestimates the power density in the near field area around the antenna. From observations and theory, according to one embodiment of the invention an algorithm has been developed for determining how far away the far field is from an antenna (and hence when the far field power density formula becomes accurate). The algorithm is described in greater detail hereinafter.

If the effective aperture of the antenna is less than 1 wavelength at the operating frequency then:

$${D}_{far - field} = \frac{wavelength}{2 π} .$$

If the effective aperture is greater than or equal to 1 wavelength at the operating frequency, then:

$${D}_{far - field} = \frac{2 * Aea}{wavelength}$$

wherein Aea is the antenna's effective aperture.
Near Field Calculations

To compensate for the overestimating effect of just using far field calculations it is necessary to determine the reduction in gain in the near field due to the finite size of the aperture. From power density observations for uniform line sources and tapered illumination aperture antennas a general break point distance must be determined where calculations change modes between near field and far field. An associated taper method can be used to calculate near field radiation levels. The break point for parabolic antennas is determined as 0.16 times the far field distance. The taper method for the parabolic antenna is defined as:
Pd_{parabolicNF}=41.3*Pd
where the Di used in the Pd calculations is just Dfar-field, irrespective of how close a distance to the antenna. The break point for rectangular aperture antennas is defined as 0.25 times the far field distance. The taper method for the rectangular antenna is defined as:
Pd_{RectangularNF}=Pd
where the Di² used in Pd is replaced with Di times the breakpoint distance. This effectively makes the power density decay with a rate of 1/Di in the near field rather than 1/Di² (which occurs in the far field).

These taper methods can be seen to still overestimate in the near field, but to a much lesser extent. This small overestimation builds some tolerance into the calculations to cater for antennas that may have differing properties different to those exhibited.

Aperture Antennas

Before power density levels can be determined for an antenna it is necessary to identify key characteristics of the antenna. This enables the antenna to be accurately modeled.

According to one embodiment the far field radiation pattern can be determined from the Fourier transform of the electric field across the aperture. When most of the radiation is concentrated in a highly directional beam, then close to the antenna there is no significant diffraction pattern when observed close to the main beam direction. That is radiation from any point source in the aperture travels almost the same distance as radiation from any other point source in the aperture when the observation point is confined to the non-shadow region—the aperture dimensions translated in the direction of the radiation, a simple inverse square law can be applied and a good approximation to the radiation levels is obtained. In the shadow, i.e. outside the aperture translated in the direction of the main beam, diffraction effects occur and the field is attenuated.

The optical equivalent is a parallel ray of light falling on an irregular hole in an opaque material. When observed very close to the opaque material, the shape of the light beam is the same as the irregular hole (the Fresnel region). When observed far from the irregular hole, the image is that of a circle (Fraunhofer region).

In order to calculate the near and far field radiation density given only two orthogonal radiation patterns and the power supplied to the aperture antenna, the mechanical structure must be determined from these radiation patterns. Once an approximate aperture distribution is known the antenna is modeled by point radiators, (“Huygen's wavelet sources) across the aperture.

According to the closest point algorithm method a full three-dimensional analysis of the antenna is achieved over the antennas length and width. The closest point algorithm is set out as follows:
1. Find the displacement of the analysis point and the centre of the radiating element.
2. Calculate the effective reduction of antenna aperture as a result of the displacement.
3. Find the displacement vectors x, y and z dimension values between the centre of the antenna and the point of analysis.
4. Rotate the displacement vector by the antenna's mechanical downtilt in three-dimensional space (to calculate the analysis with respect to the antenna face).
5. Find the Azimuth angle (the angle in the XY plane from the centre of the antenna's aperture face to the analysis point in the X-Y plane);
6. Find the Elevation angle (the angle in the Z plane from the centre of the antennas aperture face to the analysis point in the Z plane);
   analysis height going along the antenna height plane (obtain through the rotated displacement's z dimension);
8. From the rotated displacement, obtain the analysis distance along the antenna width plane (obtained through the rotated displacement's xy plane vector's component along the antenna face
9. If the offset (analysis displacement height+electrical downtilt compensation is inside +/−½ the effective antenna height, then the new source Z position is set to the antenna's centre height+the Z component of the downtilted offset
   Else
   The new Z position is set to the sign of the offset *½ the effective antenna height;
10. If the antenna width plane offset is inside =/−½ the effective antenna width, then the new source X and Y positions are set to the antenna's centre X and Y positions+the width offset along the antenna face+X and Y components of the downtilted elevation offset,
   Else,
   The new X and Y positions are set to the sign of the offset *½ the effective antenna width.

The new antenna source positions are then used in the calculation at this analysis point.

In the summary the closest point algorithm determines that for any point in space either within or outside the near field/far field radiation boundary, the power density level at the point in space is measured relative to only one point on the aperture antenna. This point is the closest point according to the displacement data which is determined from measuring the X, Y, Z coordinates of the point in space as well as the elevation angle and azimuth angle. For each point in space the radiating point of the aperture is merely shifted to the most appropriate position to become the closest point on the antenna to the point in space.

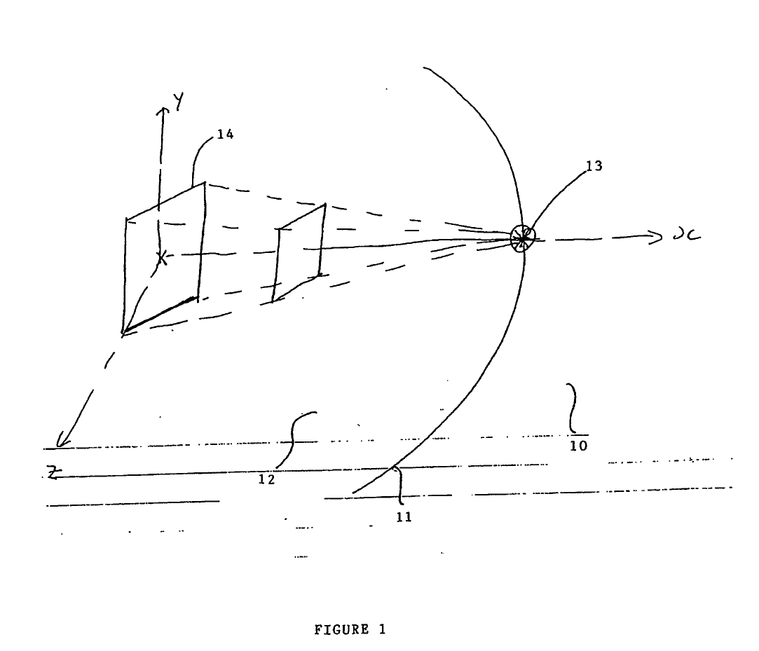

Referring to FIG. 1 for points in space lying in the Far field 10 power density calculations can be made by simply using the previously highlight power density formula. However for points in the Near field 12 inside the boundary 11 the taper function must be applied to accurately determine power density level. This taper function linearly reduces the effective aperture size in length and width as the distance from the antenna increases, until the Far field distance is reached, at which point the closest point algorithm merges back into a point source analysis. The Near field calculations are based on the modifying factors incorporated into the power density Near field formulas hereinbefore described.

The closest point algorithm also takes account of the orientation of the antenna including its tilt.

For any point 13 in space which is outside the face of the antenna aperture, the closest point source would be on the perimeter of the aperture 14.

As an alternative to the closest point algorithm method power density levels can be determined using an accumulated point source method.

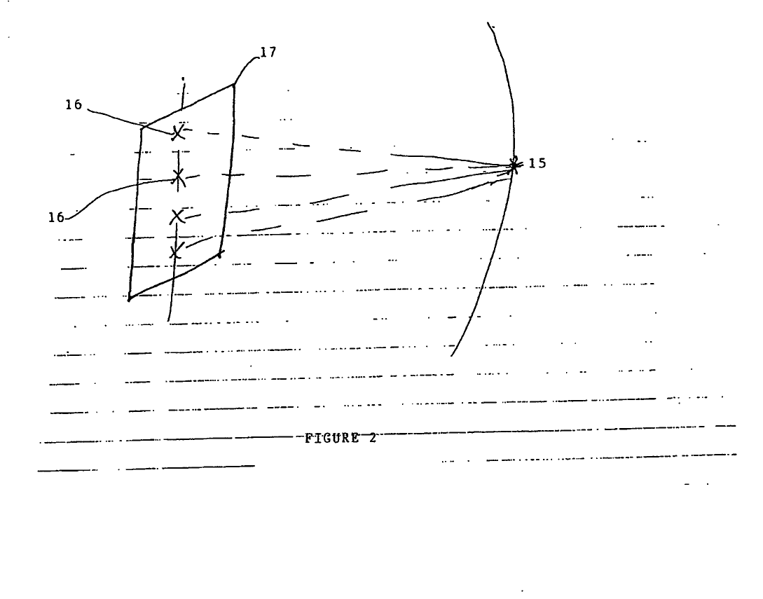

Thus as shown in FIG. 2 a point in space 15 has a power density level which is determined by the accumulated effect of point sources 16 on the antenna aperture 17.

As with the closest point algorithm method the aperture antenna must first be modeled from the two orthogonal far field radiation patterns. The size of the antenna aperture is then calculated in conjunction with data on the physical size of the structure.

Once the size and shape of the aperture has been determined the aperture is then represented by a number of Huygen's wavelet sources. The number of wavelet sources may be determined by using a single point source for each element with a length less than half a wavelength. For elements longer than this the number of point sources increases proportionately with the number of half wavelengths in the element.

As an example the Yagi-Uda style antenna is discussed. The 3 dB beam width in the two orthogonal radiation patterns are used to gain an estimate of the number of elements in the Yagi-Uda antenna. A standard configuration is then used to represent the antenna.

The sum of the contributions from each point source to every point in space in the vicinity of the antenna is used to determined the Near and Far field intensities. Thus as shown in FIG. 2 the contributions from each of the point sources 16 are combined to provide a power density level at point 15.

As with the closest point algorithm the field strengths are scaled in accordance with the power supplied to the antenna.

Exposure Limits Comparison

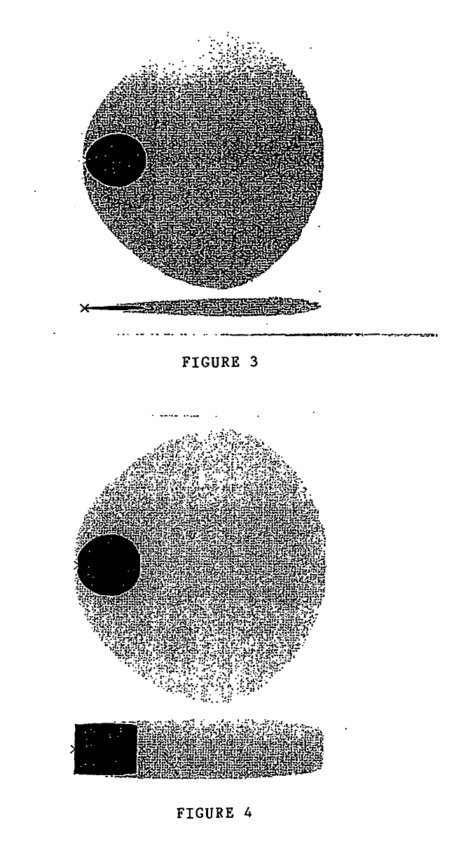

The following diagrams display the exposure limit boundaries (using 2 and 10 W/m² for the red and yellow zones respectively) of the existing and new calculation techniques for plan (horizontal) and elevation (vertical) boresignts of the test antenna, the Argue CTA610D-R. Note that in the traditional full modeling solution the antenna is identified as a point source located at its phase centre. See FIG. 3

Power Density Comparison

The following diagrams represent the power density graphical representations of the existing and new algorithms for the test antennas, of the type Decibel DB580y (omnidirectional). Note that in the traditional full modeling solution, the antenna is identified as a point source located at its phase centre. See FIG. 4

Wire Antennas

The Huygen's wavelet method can also be applied to wire antennas. Such antennas can be classified as Yagi-Uda, Log Periodic, Phased Arrays of Monopoles and Dipoles and Rhombic. The fields are calculated using a single point source for each element with length less than half a wavelength. For elements longer than this the number of point sources increases proportionately with the number of half wavelengths in the elements.

As with the aperture antennas before the wire antennas can be properly modeled it is necessary to obtain the 3 dB bandwidth in the two orthogonal radiation patterns. Once this has been done an estimate may be made of the number of elements N in the antenna.

With the number of elements equaling:

$$N = \frac{2 l}{λ}$$

where l is the length of the antenna and λ is wavelength
   the length and space of each of the wire elements can be determined.

The method then requires a calculation of the mutual coupling between all elements in the array and the assembly of the N×N impedance matrix.

To obtain the current I in each element the inverse impedance Z matrix is multiplied by the column voltage V vector (o for parasitic elements, 1 volt for the driven element).

$$[ \begin{matrix}{I}_{1} \\ {I}_{2} \\ ⋮ \\ {I}_{n}\end{matrix} ] = {[ \begin{matrix}{Z}_{11} & ⋯ & {Z}_{n1} \\ {Z}_{12} & ⋰ & ⋮ \\ ⋮ & ⋰ & ⋮ \\ {Z}_{1 n} & ⋯ & {Z}_{nn}\end{matrix} ]}^{- 1} [ \begin{matrix}{V}_{1} \\ {V}_{2} \\ ⋮ \\ {V}_{n}\end{matrix} ]$$

This gives an example for determining the current for an n element array.

A Huygen's wavelet point source is then assigned to the current locations of each element in the antenna. The magnitude and phase of the point source is directly proportional to the current calculated previously.

Assuming a sin(θ) dependence for each wire element (θ is measured from the direction of the elements), the contribution of each point source is added to every point in space in the vicinity of the antenna. This includes both near and far field affects. Thus the effect of each point source on a point in space is calculated in determining the overall power density level at the point in space. This is similar to the approach used in the Huygen's wavelet method used for the aperture antenna algorithm.

Field strengths are also scaled dependent upon the power supply to the antenna.

The effect of metallic and dieletric support structures can be modeled by point sources using image theory. These images contribute to the array of point sources in the model and the field intensity calculations are made as before.

In its preferred form the above described embodiments of the invention are implemented by computer software. The software is preferably configured to store data relating to different types of antenna. This data would include manufacturers antenna pattern files in a number of different standard formats. In this way it is possible to compare an antenna being modeled with existing data.

If an antenna being modeled does not fit an existing manufacturers antenna pattern file the software is able to receive measured data relating to antenna patterns and create an appropriate file. This can be added to a main database for storing antenna pattern files.

Typical antenna pattern properties which are stored include pattern type, frequency for that pattern, system loss, resolution, linear averaged, pattern cut, pattern type, electric tilt and effective gain.

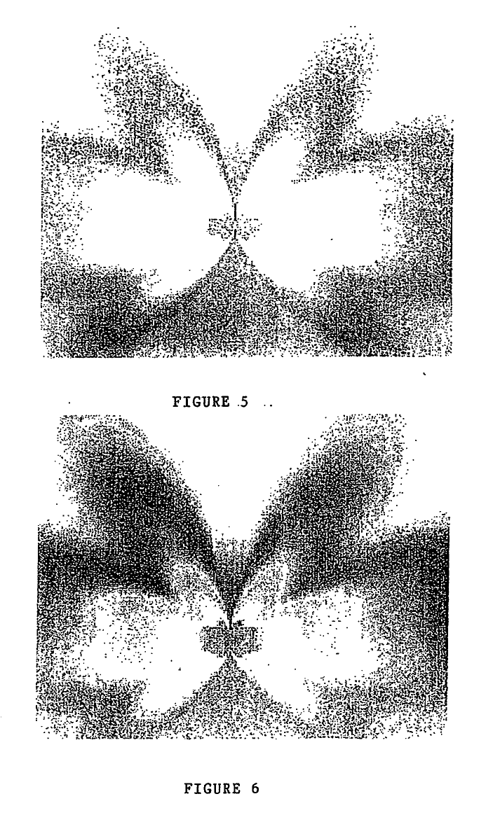

In addition to the above files storing basic antenna patterns may include data relating to the horizontal beam width, the vertical beam width and the front to back ratio. It is preferred that once the main characteristics of an antenna have been characterised the antenna can be modeled according to one of the above described methods. A power density graphical or visual representation then can be obtained and the software is able to highlight the near field and far field radiation patterns using different colours. These differences are highlighted in black and white in FIGS. 3 to 6.

It is preferred that the software is able to select a number of resolution options so that the resolution of the power density patterns can be varied.

It is also preferred that the software is able to record safe power density levels and restrict the images produced for near field and far field radiation to the safety values. This diagrams can be produced which show only the hazardous levels of radiation.

1. A method for determining field radiation levels for a radiating device comprising
determining far field radiation characteristics of a radiating device,
providing a model of the radiating device, which model approximates the determined far field radiation characteristics and
determining a near field radiation characteristic from the model for at least one point in space.

2. The method as claimed in claim 1 including the step of determining a boundary between the near field and far field radiation of the radiating device.

3. The method as claimed in claim 1 including the step of determining near field radiation density from the model.

4. The method as claimed in claim 3 including the step of determining power density level over a plurality of positions in space.

5. The method as claimed in claim 4 including the step of determining beam width characteristics of the radiating device in two orthogonal far field radiation patterns.

6. The method as claimed in claim 5 including the step of determining the 3 dB beam width in two orthogonal far field radiation patterns.

7. The method as claimed in claim 6 including the step of determining physical characteristics of the radiating device to determine the far field radiation characteristics.

8. The method as claimed in claim 7 including the step of providing a model including representing the device by a plurality of radiation sources.

9. The method as claimed in claim 1 wherein the radiating device comprises a wire antenna.

10. The method as claimed in claim 9 including the step of providing a model including representing the radiating device by a plurality of wire elements.

11. The method as claimed in claim 10 including the step of estimating the length and spacing of each wire element forming the radiating device.

12. The method as claimed in claim 11 wherein each wire element is represented as a radiation source.

13. The method as claimed in claim 12 including the step of calculating mutual coupling between all the wire elements.

14. The method as claimed in claim 13 including the step of assembling an N by N impedance matrix and calculating the voltage for each element to determine the current in each element.

15. The method as claimed in claim 14 including the step of multiplying the inverse impedance matrix by the column voltage vector to determine the current in each element.

16. The method as claimed in claim 15 including the step of assigning a Huygen's wavelet point source to each element and calculating the magnitude and phase of each wavelet point source from the current determined.

17. The method as claimed in claim 16 including the step of summing the contribution of each point source to each point in space within the near field.

18. The method as claimed in claim 1, including the step of providing a single point source for each element with a length less than half a wavelength.

19. The method as claimed in claim 1 wherein the radiating device is an aperture antenna.

20. The device as claimed in claim 19 including the step of determining the physical characteristics of the radiating device and providing a model including representing the aperture by at least one Huygen's wavelet source.

21. The method as claimed in claim 20 including the step of summing the contribution from each wavelet source to each point in space.

22. The method as claimed in claim 21 wherein the power density level at any point in space is determined using the formula
$$Pd = \frac{PoweratAntenna * {10}^{\frac{Gd + 2.15}{10}}}{4 π {Di}^{2}} .$$

23. A method of estimating radiation power density of electromagnetic radiation comprising the steps of
determining a model for a radiating device based on radiation patterns,
representing the radiation device as a plurality of point sources which radiate electromagnetic radiation,
estimating power density level at a plurality of positions in space for each point source and
determining the total power density level at each position, by summing the contribution of each point source to the respective positions in space.

24. The method as claimed in claim 23 including the step of displaying the power density level for a plurality of positions.

25. The method as claimed in claim 24 including summing the power density level determined at each position for all point sources representing the radiating device.

26. The method as claimed in claim 25 including the step of calculating far field and near field tapering characteristics for each position.

27. The method as claimed in claim 26 including the step of calculating the power density level at a point in space by using the power density formula
$$Pd = \frac{PoweratAntenna * {10}^{\frac{Gd + 2.15}{10}}}{4 π {Di}^{2}}$$
for far field radiation and modifying the far field power density formula for near field radiation, which modification affects the antenna gain, power sent to the antenna and the distance from the antenna to the point source.

28. A method of determining field radiation levels for a radiating device comprising the steps of
determining far field radiation characteristics of a radiating device,
determining the boundary between near field and far field radiation,
determining the displacement of a point in space relative to the closest point on the radiating device and
calculating the power density level at the point in space.

29. The method as claimed in claim 28 including the step of modeling the radiating device as a plurality of point sources.

30. The method as claimed in claim 29 including the step of applying a closest point algorithm to determine the power density level at each point in space.

31. The method as claimed in claim 30 wherein the closest point algorithm determines the displacement of the point in space from the closest point on the radiating device.

32. The method as claimed in claim 31 wherein the closest point algorithm calculates X, Y, Z displacement vectors from the point in space to the closest point on the radiating device and calculates azimuth and elevation angles to the closest point.

33. The method as claimed in claim 33 wherein the closest point algorithm determines the orientation of the radiating device and scales the power density level determined according to the orientation of the radiation device.

34. The method as claimed in claim 34 wherein the closest point algorithm calculates the power density level using the power density formula and incorporates any modification factor applicable if the point in space is in the near field.

35. The method as claimed in claim 23 wherein the model for the radiating device is determined from two orthogonal far field radiation patterns.
